(19) United States
(12) Patent Application Publication
(10) Pub. No.: US 2008/0229666 A1
(43) Pub. Date: Sep. 25, 2008

(54) Gate opening and closing apparatus

(76) Inventor: Michael Wayne Jones, Pensacola, FL (US)

Correspondence Address: Peter Loffler, P.O. Box 1001, Niceville, FL, 32588-1001, US

(21) Appl. No.: 11/725,215

(22) Filed: Mar. 19, 2007

(51) Int. Cl. E05F 15/10

(52) U.S. Cl. 49/334; 49/336

(57) ABSTRACT

A gate opener has a slide gate panel that slides between an open position and a closed position in order to control passage through the gate. A support plate has a lower spindle support and an upper spindle support and is secured to the ground in appropriate fashion. A motor assembly is rotatably disposed between the lower spindle support and the upper spindle support and has a sprocket operationally attached thereto. When the bidirectional motor within the motor assembly is operational, the sprocket, which directly gearably meshes with a drive rack gear on the gate, rotates causing the gate to slide back or forth. A magnetic reed switch on the sprocket, support plate or control box, senses the presence of a magnet located on either end of the gate deactivates the motor reverse its direction for the next cycle.

### BACKGROUND OF THE INVENTION

1. Field of the Invention

The present invention relates to an apparatus that automatically opens and closes a sliding gate assembly.

2. Background of the Prior Art

Gates are popular access control devices that help restrict vehicular and pedestrian traffic to a wide array of locations where such traffic control is desired. Apartment complexes, houses, ranches, various work sites, and security control areas are typical locations where gates are can oftentimes be found. These access control gates come in one of two broad categories.

Some gates are manual in that the gate must be opened and closed manually by an operator. A user opens the gate in order to allow a vehicle or a person to pass through the gate and thereafter closes the gate in order to again restrict access therethrough. Such gates are typically found in relatively remote locations, such as a side entrance to a ranch, wherein the frequency of ingress and egress through the gate is relatively sparse and in areas where an attendant is on duty to help control access through the gate. A military site and a delivery parking lot are examples of gate locations of the latter type.

The other major category of access control gates is automatic gate openers in that the gate, through an appropriate action of a user, automatically opens and closes. A user may use a remote control device, may punch in a code linked to a key pad, swipe an access card, be seen by an electric eye, or just drive onto a weight sensing section of roadway in order to activate the automatic opening or closing of the gate. Additionally, the gate may be activated by an operator on duty or by a person located at a site remote of the gate who has some form of audio or visual access (closed circuit TV, for example) to the gate area. Such persons operate the gate as they see fit depending on the nature of the person or vehicle desiring passage through the gate area.

Most automatic opening and closing gates fall into one of three types. One type of automatic gate is one that is raised and lowered in order to control access. Most of these types of gates are some form of swing arm that is raised to allow passage through the gate area and is lowered to restrict access. These types of gates, which tend to be relatively inexpensive, are often found at parking lots, roadway toll booths, and railroad track crossings.

Another type of gate is a swinging gate that is spindle supported between an open and a closed position. Typically, the spindle supporting of the gate is actuated by either a hydraulic or pneumatic piston or a solenoid rod wherein extension of the piston or solenoid rod places the gate into a closed position and retraction of the piston or solenoid rod swings the gate into an open position. These types of gates are often found at condominium parking lots and at exclusive houses and neighborhoods and are very popular.

A third type of automatic gate is a sliding gate wherein the gate opens and closes by sliding or rolling back and forth through the gate access area. A motor controls the operation of the gate and is linked to the gate through some form of chain or gear drive, wherein upon activation of the motor, the drive becomes operational and controls back and forth movement of the gate panel, or the motor is connected directly to the gate panel and has some form of drive wheels that allow the back and forth movement of the gate panel. Activation of the motor drives the wheels which move the gate panel in the appropriate direction. These types of gates tend to be used in similar situations as the automatic swinging gate, where use of the swinging gate is not feasible. For example, in many situations, there is insufficient clearance for the arc of the opening swinging gate panel. A gate panel cannot open in order to allow a homeowner to leave his or her property and whack a car driving down the street proximate the gate assembly. The sliding gate uses a pocket into which the gate panel slides when it is opened. Therefore, as long as there is sufficient lateral space available to hold the gate panel thereat, this type of gate assembly proves satisfactory.

The problem with this type of gate assembly lies in the drive mechanism. In a chain or belt drive configuration, the chain or belt must be properly tensioned in order for the gate to operate properly. Over time, the chain or belt becomes loose and begins to slip resulting in diminished performance of the gate assembly. With time, if the belt or chain is not properly serviced, the chain or belt can completely fail resulting in a potentially expensive repair to the gate owner. Additionally, such a drive mechanism takes up a large amount of real estate and is unsightly unless it is properly shielded, further taking away from the usable real estate of the property upon which the gate assembly is installed. Additionally, debris can be picked up by the belt or chain which debris can clog up the drive mechanism of the gate assembly rendering the gate assembly inoperable, again leaving the owners with gate down time, including the potential for not being able to properly ingress and egress onto the property as well as the attendant repair costs.

In order to address these problems, sliding gates have been proposed that employ a gear drive to open and close the gate panel. The gear drive eliminates the linking belt or chain and eliminates the tensioning problems associated with such drive linkages. Additionally, such gear drives tend to occupy a much smaller amount of real estate than gates employing a linkage. However, the problem with such prior art devices is that they are unduly complex in design and construction making such devices relatively expensive to manufacture and maintain.

Therefore, there exists a need in the art for an automatic sliding gate assembly that addresses the above-stated problems found in the art. Specifically, a gate opening and closing apparatus is needed wherein the gate assembly employs a gear drive mechanism so as to eliminate the use of a chain or belt linkage and the problems attendant with such drive mechanisms so as to minimize the required real estate needed for such devices. Such a gate opening and closing apparatus must be of relatively simple design and construction so that it is relatively inexpensive to manufacture, install and maintain.

### SUMMARY OF THE INVENTION

The gate opening and closing apparatus of the present invention addresses the aforementioned needs in the art. The gate opening and closing apparatus is an automatic sliding gate assembly that eliminates the chain or belt linkage between the drive mechanism and the actual gate panel thereby eliminating the problems associated with such linkages. The gate opening and closing apparatus relies on a direct gear drive that occupies a relatively small amount of real estate and that is compact in configuration so that a landscape architect or other professional can aesthetically hide the drive mechanism from general view. The gate opening and closing apparatus is of relatively simple design and construction making the device relatively inexpensive to manufacture, install and maintain.

The gate opening and closing apparatus of the present invention is comprised of a support plate that has a lower spindle support and an upper spindle support, the support plate secured to the ground in appropriate fashion, either as a standalone (post sunk in ground, etc.), or secured to another object such as a proximate building. A motor assembly, having a bidirectional motor, is rotatably disposed between the lower spindle support and the upper spindle support while a drive sprocket is operationally attached to the motor assembly such that when the motor assembly is operational, the drive sprocket rotates. The drive sprocket is gearably meshed with a drive rack gear located along a length of a slide gate panel such that rotation of the drive sprocket causes the slide gate panel to travel back or forth depending on the direction of rotation of the sprocket (and thus the motor). A magnetic reed switch is located within the drive sprocket, on the support plate, or within a device control box that is located proximate the gate panel such that the slide gate panel has a pair of magnets, one magnet at either end of the gate and such that when the magnetic reed switch encounters one of the pair of magnets, the motor is deactivated, and its direction of rotation reversed for the next operational cycle. The motor assembly is comprised of a lower spindle that is secured to the lower spindle support. The bidirectional motor rotatably positioned on the lower spindle assembly. A lovejoy coupling is operatively connected to the motor and a motor coupling is mated with the lovejoy coupling. An outer tube overlies the motor and is coupled to the motor coupling and to the drive sprocket. The outer tube is rotatably connected to the upper motor support. Upon activation of the motor, the lovejoy coupling rotates causing the motor coupling to rotate, in turn causing the outer tube to rotate, in turn causing the drive sprocket to rotate. A first cap is positioned atop the upper spindle support while a second cap is attached to the underside of the lower spindle support.

### BRIEF DESCRIPTION OF THE DRAWINGS

FIG. 1 is a perspective view of the drive mechanism of the gate opening and closing apparatus of the present invention.

FIG. 2 is a plan view, from the bottom, of the drive mechanism of the gate opening and closing apparatus.

FIG. 3 is a plan view, from the bottom, of the drive mechanism interacting with a slide gate panel.

FIG. 4 is a partially exploded view of the drive mechanism, the outer tube, and the spindle supports.

FIG. 5 is an exploded view of the sprocket assembly, lower spindle, and lower spindle support.

FIG. 6 is an exploded view of the gate opening and closing apparatus with the top and bottom caps and the drive motor omitted for clarity.

FIG. 7 is an exploded view of the drive motor, motor couplings, and lower spindle support.

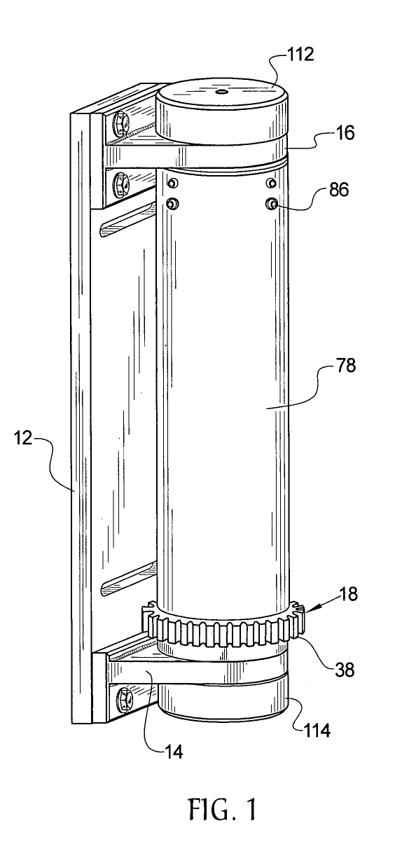

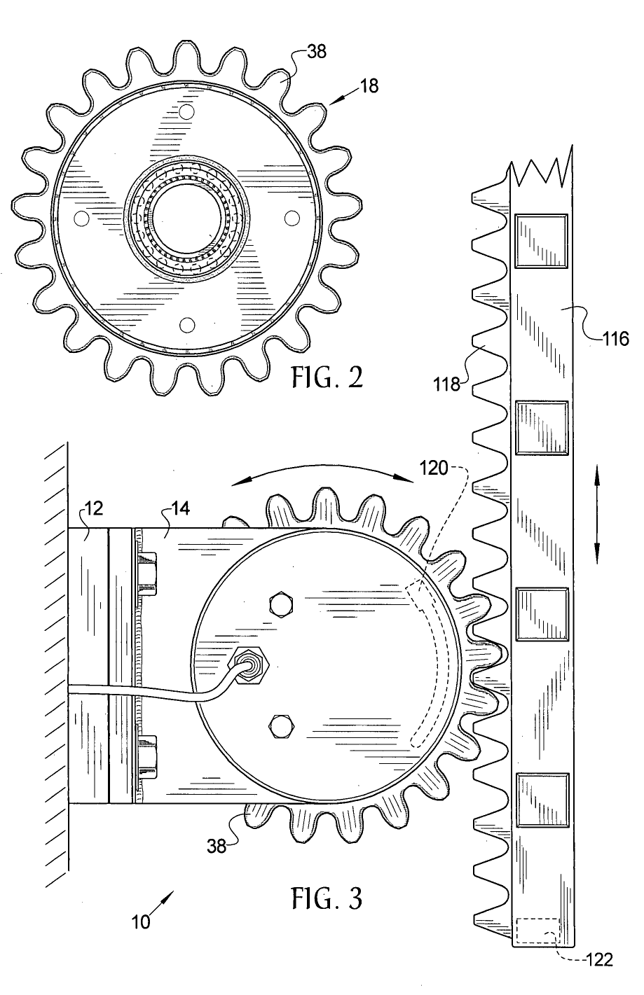

Similar reference numerals refer to similar parts throughout the several views of the drawings.

### DESCRIPTION OF THE PREFERRED EMBODIMENT

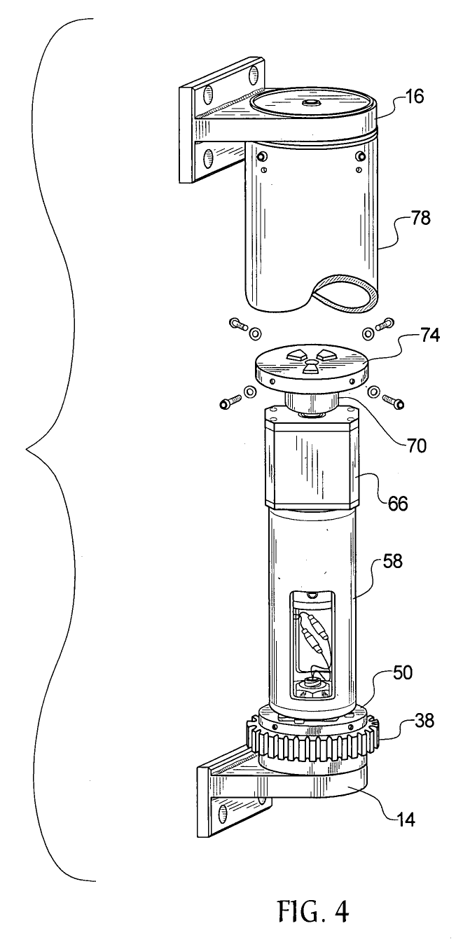

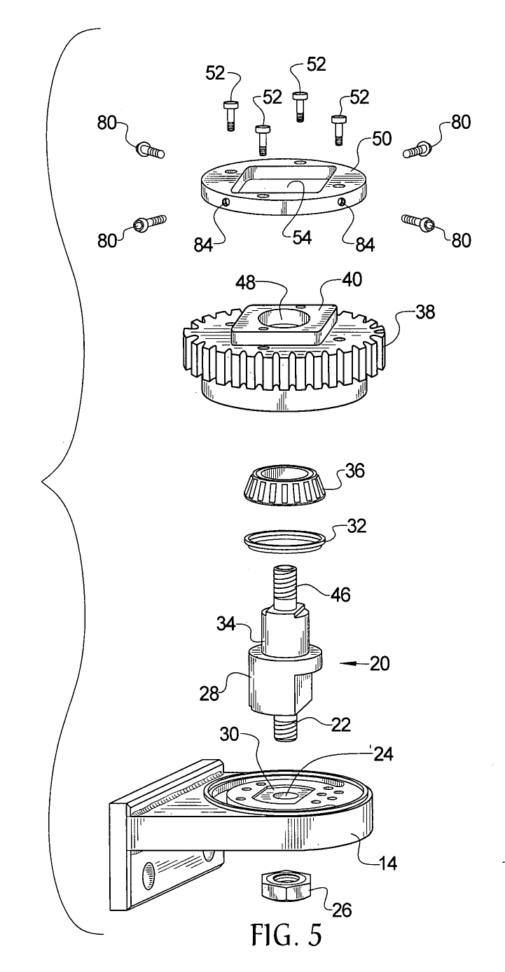

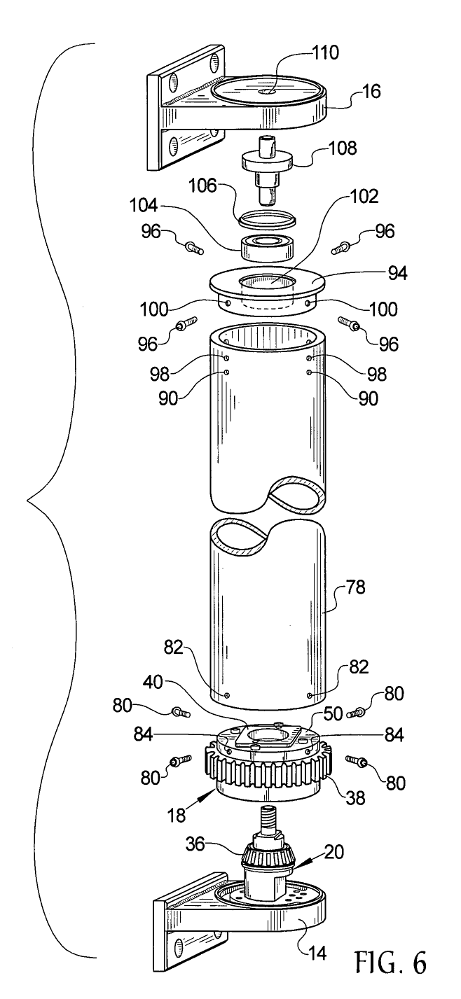

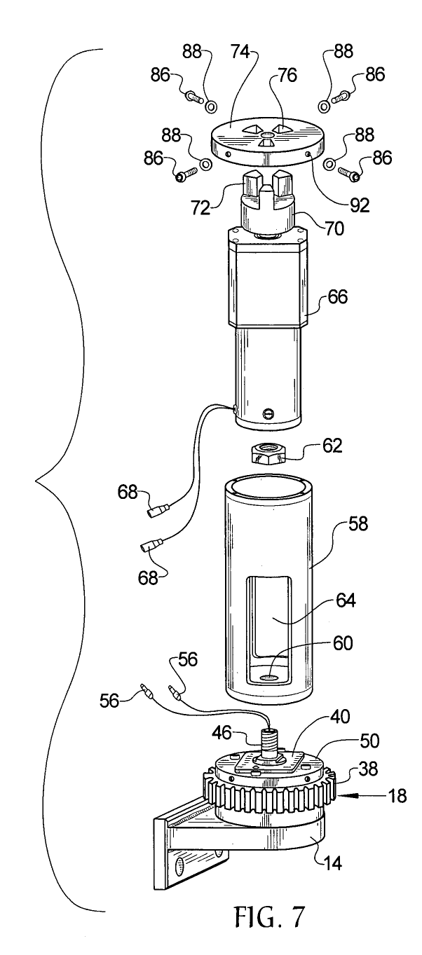

Referring now to the drawings, it is seen that the gate opening and closing apparatus of the present invention, generally denoted by reference numeral 10, is comprised of support plate 12 attached to an appropriate post, building, etc., (none illustrated) and to which a lower spindle support 14 and an upper spindle support 16 are attached. A drive sprocket assembly 18 rotatably sits within the lower spindle support 14. The sprocket assembly 18 comprises a lower spindle 20 that has a lower shaft 22 which protrudes through an opening 24 located on the lower spindle support 14 and has a lower spindle retention nut 26 threadably attached thereonto to hold the lower spindle 20 in place with the lower body section 28 of the lower spindle 20 sitting in an appropriately sized recess 30 on the lower spindle support in order to help maintain the lower spindle 20 in place. A lower seal 32 encompasses the lower body section 28 of the lower spindle 20. A lower bearing 36 sits above the lower seal 32 and encompasses the upper body section 34 of the lower spindle 20. A drive sprocket 38 sits atop the lower bearing 36, the drive sprocket 38 having a lower bearing housing 40 located on an upper surface thereof. The upper shaft 46 of the lower spindle 20 protrudes through an opening 48 located on the lower bearing housing 40. A lower tube mount 50 sits atop the drive sprocket 38 and is attached thereto by passing appropriate screws 52 through the lower tube mount 50 and into the drive sprocket 38. The lower tube mount 50 receives the lower bearing housing 40 within an opening 54 on the lower tube mount 50, which opening 54 is sized and dimensioned to snugly receive the lower bearing housing 40 therein. As best seen in FIGS. 4 and 7, appropriate electrical leads 56 internally pass through the drive sprocket assembly 18 including the lower spindle 20, which leads 56 are connected to an appropriate source of electrical power in the usual way (connection not illustrated).

A motor tube 58 is fitted overtop the drive sprocket assembly 18 such that the upper shaft 46 of the lower spindle 20 passes through an opening 60 located on the motor tube 58 with a retention nut 62 threadably attached thereonto in order to hold the motor tube 58 properly in place. As seen, the motor tube 58 has appropriate service openings 64 thereon. A drive motor 66 is partially received within the motor tube 58, the motor 66 having appropriate electrical leads 68 that are electrically mated with the leads 56 that pass through drive sprocket assembly 18, thereby connecting the motor 66 to the source of electrical power. Extending upwardly from the motor 66 is a lovejoy coupling 70 that has a series of protrusions 72 thereon. A motor coupling 74 has a series of openings 76 that correspond to and receive the protrusions 72 of the lovejoy coupling 70.

An outer tube 78 overlies the motor 66 and the motor tube 58, the outer tube 78 sitting atop the drive sprocket 38. The outer tube 78 is attached to the lower tube mount 50 by passing appropriate screws 80 through openings 82 on the outer tube 78 which openings 82 correspond to and align with openings 84 located on the lower tube mount 50. Similarly, the outer tube 78 is attached to motor coupling 74 by passing appropriate screws 86 with washers 88 through openings 90 on the outer tube 78 which openings 90 correspond and align with openings 92 located on the motor coupling 74. A upper tube mount 94 is attached to the top of the outer tube 78 and is held thereat by passing appropriate screws 96 through openings 98 on the outer tube 78 which openings 98 correspond to and align with openings 100 located on the upper tube mount 94. As seen, the upper tube mount 94 has a central opening 102 which receives an upper bearing 104 therein. An upper seal 106 sits atop the upper bearing 104 while an upper spindle 108 has its lower end received within the upper bearing 104 and its upper end rotatably received within an opening 110 of the upper spindle support 16.

An upper cap 112 is attached to the top of the upper spindle support 16 in appropriate fashion while a lower cap 114 is attached to the underside of the lower spindle support 14 in appropriate fashion, the two caps 112 and 114 protecting the internal working mechanisms of the device 10.

A slide gate panel 116 has a drive rack gear 118 thereon which drive rack gear 118 gearably mates with the drive sprocket 38. When the motor 66 is activated, the drive sprocket 38 rotates. The rotating drive sprocket 38, by being gearably meshed with the drive rack gear 118 of the slide gate panel 116, causes the slide gate panel 116 to travel either back or forth depending of the direction of rotation of the motor 66 and thus the drive sprocket 38. Motor 66 activation is achieved in any appropriate manner such as by the throwing of a switch, response to a remote signal similar to a garage door opener, a switch sensing the presence of a vehicle, either by electric eye or by under surface weight, etc. (none illustrated).

A magnetic reed switch 120 is located on the drive sprocket 38 at an appropriate location, or on the support plate 12, or on the control box (not illustrated) such that a pair of magnets 122 (only one illustrated) are located on either end of the slide gate panel 116 in order to limit gate 116 travel such that when the reed switch 120 senses the presence of a magnet 122—end of slide gate panel 116 encountered—the motor 66 is deactivated and the system reverses the direction of rotation of the motor 66 upon the motor's next activation.

While the invention has been particularly shown and described with reference to an embodiment thereof, it will be appreciated by those skilled in the art that various changes in form and detail may be made without departing from the spirit and scope of the invention.

I claim:

1. A gate opener comprising:
a support plate;
a slide gate panel having a drive rack gear thereon;
a bidirectional motor attached to the support plate; and
a drive sprocket operationally attached to the motor and directly gearably meshed with the drive rack gear such that when the motor is operational, the drive sprocket rotates and causes the slide gate panel to travel back or forth.

2. The gate opener as in claim 1 further comprising a magnetic reed switch such that the slide gate panel has a pair of magnets, one magnet at either end of the slide gate panel, such that when the magnetic reed switch encounters one of the pair of magnets, the motor is deactivated.

3. A gate opener comprising:
a support plate having a lower spindle support and an upper spindle support;
a slide gate panel having a drive rack gear thereon;
a motor assembly rotatably disposed between the lower spindle support and the upper spindle support; and
a drive sprocket operationally attached to the motor and directly gearably meshed with the drive rack gear such that when the motor is operational, the drive sprocket rotates and causes the slide gate panel to travel back or forth.

4. The gate opener as in claim 3 comprising a magnetic reed switch such that the slide gate panel has a pair of magnets, one magnet at either end of the slide gate panel, such that when the magnetic reed switch encounters one of the pair of magnets, the motor is deactivated.

5. The gate opener as in claim 5 further comprising a first cap attached to a top of the upper spindle support.

6. The gate opener as in claim 5 further comprising a second cap attached to an underside of the lower spindle support.

7. The gate opener as in claim 3 wherein the motor assembly is comprised of:
a lower spindle assembly that is secured to the lower spindle support;
a bidirectional motor rotatably positioned on the lower spindle support;
a lovejoy coupling operatively connected to the motor;
a motor coupling mated with the lovejoy coupling;
an outer tube overlying the motor and coupled to the motor coupling and to the drive sprocket, the outer tube rotatably connected to the upper spindle support; and
wherein upon activation of the motor, the lovejoy coupling rotates causing the motor coupling to rotate, in turn causing the outer tube to rotate, in turn causing the drive sprocket to rotate.

8. The gate opener as in claim 7 comprising a magnetic reed switch such that the slide gate panel has a pair of magnets, one magnet at either end of the slide gate panel, such that when the magnetic reed switch encounters one of the pair of magnets, the motor is deactivated.

9. The gate opener as in claim 7 further comprising a first cap attached to a top of the upper spindle support.

10. The gate opener as in claim 9 further comprising a second cap attached to an underside of the lower spindle support.
